(19) United States
(12) Patent Application Publication
(10) Pub. No.: US 2026/0270795 A1
(43) Pub. Date: Sep. 10, 2026

(54) RECOMMENDED BITRATE WITH USER EXPERIENCE AWARENESS

(71) Applicant: QUALCOMM Incorporated, San Diego, CA (US)

(72) Inventors: Hyun Yong LEE, San Diego, CA (US); Hong CHENG, Basking Ridge, NJ (US); Linhai HE, San Diego, CA (US); Belal Salama Amin KORANY, San Diego, CA (US); Peerapol TINNAKORNSRISUPHAP, San Diego, CA (US); Prashanth Haridas HANDE, San Diego, CA (US)

(21) Appl. No.: 19/073,546

(22) Filed: Mar. 7, 2025

(51) Int. Cl. H04W 28/22; H04L 65/80

(52) U.S. Cl. CPC H04W 28/22; H04L 65/80

(57) ABSTRACT

This disclosure provides methods, components, devices and systems for recommended bitrate with user experience (UX) awareness. For example, a user equipment (UE) may transmit recommended bitrate information, such as a bitrate recommendation query, for an application based on UX awareness. The bitrate recommendation query may indicate one or more values for a quality of experience (QoE) metric and one or more bitrates that correspond to those values of the QoE metric. For example, the UE may indicate quantized information from a curve that maps bitrate to QoE for the application, indicating a QoE level for one or more corresponding bitrates. The bitrate recommendation query may indicate a type of QoE according to the application. The bitrate recommendation query may indicate a time window during which the bitrate recommendation query information is valid.

### TECHNICAL FIELD

This disclosure relates generally to wireless communication, and more specifically to systems, devices, methods, and techniques associated with recommended bitrate with user experience (UX) awareness.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include transmitting a first message including bitrate query information associated with an application, the bitrate query information indicating one or more quality of experience (QoE) metrics and one or more bitrates that correspond to the one or more QoE metrics, receiving a second message including bitrate information associated with the application based on the bitrate query information, and communicating data for the application in accordance with the bitrate information.

A UE for wireless communications is described. The UE may include a processing system that includes processor circuitry and memory circuitry that stores code. The processing system may be configured to cause the UE to transmit a first message including bitrate query information associated with an application, the bitrate query information indicating one or more QoE metrics and one or more bitrates that correspond to the one or more QoE metrics, receive a second message including bitrate information associated with the application based on the bitrate query information, and communicate data for the application in accordance with the bitrate information.

Another UE for wireless communications is described. The UE may include means for transmitting a first message including bitrate query information associated with an application, the bitrate query information indicating one or more QoE metrics and one or more bitrates that correspond to the one or more QoE metrics, means for receiving a second message including bitrate information associated with the application based on the bitrate query information, and means for communicating data for the application in accordance with the bitrate information.

A non-transitory computer-readable medium storing code for wireless communications is described. The code may include instructions executable by one or more processors to transmit a first message including bitrate query information associated with an application, the bitrate query information indicating one or more QoE metrics and one or more bitrates that correspond to the one or more QoE metrics, receive a second message including bitrate information associated with the application based on the bitrate query information, and communicate data for the application in accordance with the bitrate information.

In some examples of the method, UEs, and non-transitory computer-readable medium described herein, transmitting the first message may include operations, features, means, or instructions for transmitting the first message including the bitrate query information that indicates a set of multiple QoE metrics of a QoE-bitrate curve associated with the application and a set of multiple bitrates of the QoE-bitrate curve that correspond to the set of multiple QoE metrics.

Some examples of the method, UEs, and non-transitory computer-readable medium described herein may further include operations, features, means, or instructions for obtaining the QoE-bitrate curve from an application server associated with the application.

In some examples of the method, UEs, and non-transitory computer-readable medium described herein, the bitrate information in the second message indicates a QoE metric of the one or more QoE metrics or an index of the one or more QoE metrics.

Some examples of the method, UEs, and non-transitory computer-readable medium described herein may further include operations, features, means, or instructions for receiving configuration information associated with the bitrate query information, the configuration information including a periodicity associated with transmission of the bitrate query information, trigger information associated with transmission of the bitrate query information, threshold information associated with transmission of the bitrate query information, or any combination thereof.

Some examples of the method, UEs, and non-transitory computer-readable medium described herein may further include operations, features, means, or instructions for receiving configuration information associated with the bitrate query information, the configuration information indicating one or more Quality of Service (QoS) flows, one or more QoE metric identifiers, one or more threshold QoE metrics, one or more threshold bitrates, a QoE metric granularity, a bitrate granularity, a threshold duration associated with the bitrate query information, or any combination thereof.

Some examples of the method, UEs, and non-transitory computer-readable medium described herein may further include operations, features, means, or instructions for transmitting capability information associated with the bitrate query information, the capability information indicating support for transmission of the bitrate query information, one or more QoS flows associated with the bitrate query information, or any combination thereof.

A method for wireless communications by a network node is described. The method may include obtaining a first message including bitrate query information associated with an application at a UE, the bitrate query information indicating one or more QoE metrics and one or more bitrates that correspond to the one or more QoE metrics, outputting a second message including bitrate information associated with the application at the UE based on the bitrate query information, and communicating data for the application in accordance with the bitrate information.

A network node for wireless communications is described. The network node may include a processing system that includes processor circuitry and memory circuitry that stores code. The processing system may be configured to cause the network node to obtain a first message including bitrate query information associated with an application at a UE, the bitrate query information indicating one or more QoE metrics and one or more bitrates that correspond to the one or more QoE metrics, output a second message including bitrate information associated with the application at the UE based on the bitrate query information, and communicate data for the application in accordance with the bitrate information.

Another network node for wireless communications is described. The network node may include means for obtaining a first message including bitrate query information associated with an application at a UE, the bitrate query information indicating one or more QoE metrics and one or more bitrates that correspond to the one or more QoE metrics, means for outputting a second message including bitrate information associated with the application at the UE based on the bitrate query information, and means for communicating data for the application in accordance with the bitrate information.

A non-transitory computer-readable medium storing code for wireless communications is described. The code may include instructions executable by one or more processors to obtain a first message including bitrate query information associated with an application at a UE, the bitrate query information indicating one or more QoE metrics and one or more bitrates that correspond to the one or more QoE metrics, output a second message including bitrate information associated with the application at the UE based on the bitrate query information, and communicate data for the application in accordance with the bitrate information.

In some examples of the method, network nodes, and non-transitory computer-readable medium described herein, the bitrate query information indicates a set of multiple QoE metrics of a QoE-bitrate curve associated with the application and a set of multiple bitrates of the QoE-bitrate curve that correspond to the set of multiple QoE metrics.

Some examples of the method, network nodes, and non-transitory computer-readable medium described herein may further include operations, features, means, or instructions for outputting the QoE-bitrate curve to an application server associated with the application.

Some examples of the method, network nodes, and non-transitory computer-readable medium described herein may further include operations, features, means, or instructions for outputting configuration information associated with the bitrate query information, the configuration information including a periodicity associated with transmission of the bitrate query information, trigger information associated with transmission of the bitrate query information, threshold information associated with transmission of the bitrate query information, or any combination thereof.

Some examples of the method, network nodes, and non-transitory computer-readable medium described herein may further include operations, features, means, or instructions for outputting configuration information associated with the bitrate query information, the configuration information indicating one or more QoS flows, one or more QoE metric identifiers, one or more threshold QoE metrics, one or more threshold bitrates, a QoE metric granularity, a bitrate granularity, a threshold duration associated with the bitrate query information, or any combination thereof.

Some examples of the method, network nodes, and non-transitory computer-readable medium described herein may further include operations, features, means, or instructions for obtaining capability information associated with the bitrate query information, the capability information indicating support for transmission of the bitrate query information, one or more QoS flows associated with the bitrate query information, or any combination thereof.

### BRIEF DESCRIPTION OF THE DRAWINGS

FIG. 1 shows an example of a wireless communication system.

FIG. 2 shows an example of an architecture that supports recommended bitrate with user experience (UX) awareness.

FIG. 3 shows an example of a signaling configuration that supports recommended bitrate with UX awareness.

FIG. 4 shows an example of a process flow that supports recommended bitrate with UX awareness.

FIG. 5 shows a block diagram of a processing system that supports recommended bitrate with UX awareness.

FIG. 6 shows a diagram of a system including a device that supports recommended bitrate with UX awareness.

FIG. 7 shows a block diagram of a processing system that supports recommended bitrate with UX awareness.

FIG. 8 shows a diagram of a system including a device that supports recommended bitrate with UX awareness.

FIGS. 9 through 12 show flowcharts illustrating methods that support recommended bitrate with UX awareness.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

A wireless communications system may support advanced technologies to enable implementation of a cyber-physical network. For example, the wireless communications system may support immersive applications such as immersive virtual reality (VR) applications, augmented reality (AR) applications, extended reality (XR) applications, mixed reality applications, interactive mapping, integration of artificial intelligence, among other applications. In some aspects, immersive applications may utilize high reliability latency-bound (e.g., real-time) video streams which require little to no buffering and relatively high data rates. For such applications and other advanced technologies, it is important to maintain acceptable levels of user experience (UX) and quality of experience (QoE), for example, maintaining UX and QoE at or above a quality threshold.

In some cases, a wireless communications system may utilize measurements of data rate and latency, among other quality-based measurement frameworks, to evaluate QoE for various applications run at a user equipment (UE). However, for a given bitrate, the QoE experienced at respective UEs may be different based on the content and codec of the operations at the respective UEs. That is, due to differences in content between a first UE and a second UE, a bitrate of 5 Mbps may result in a low QoE at the first UE and a relatively higher QoE at the second UE. Additionally, QoE may flatten or saturate as bitrate increases, that a QoE metric may greatly increase when bitrate is increased at low bitrates and marginally increase when bitrate increases at large bitrates. Some wireless communications systems support bitrate adapting bitrate by communicating a recommended bitrate between a UE and a network entity. However, current bitrate adaptation techniques do not consider UX or QoE and may be insufficient for complex applications.

Aspects of the subject matter described in this disclosure relate to communicating a recommended bitrate based on UX awareness. A UE may transmit bitrate query information, such as a bitrate recommendation query, for an application based on UX. The bitrate recommendation query may indicate one or more values for a QoE metric and one or more bitrates that correspond to those values of the QoE metric. For example, the UE may indicate quantized information from a curve that maps bitrate to QoE for the application, indicating a QoE level for one or more corresponding bitrates. The bitrate recommendation query may indicate a type of QoE according to the application. The bitrate recommendation query may indicate a time window during which the recommended bitrate information (e.g., information included in the bitrate recommendation query) is valid. Additional techniques for capability signaling for the recommended bitrate information associated with UX and configuration signaling for the recommended bitrate information associated with UX are described

Particular aspects of the subject matter described in this disclosure can be implemented to realize one or more of the following potential advantages. In some examples, by including QoE information that corresponds to bitrate information in a bitrate recommendation query, the described techniques can be used to efficiently allocate a bitrate to a UE running an application to improve UX for the application. Additionally, by including QoE information that corresponds to bitrate information in a bitrate recommendation query, the described techniques can be used to improve UX for multiple UEs operating respective applications by efficiently allocating bitrate to the multiple UEs based on UX awareness. For example, a network entity allocating bitrates based on UX awareness may allocate a higher bitrate to a first UE operating a complex application and allocate a lower bitrate to a second UE operating a lower complexity application, with each bitrate corresponding to a high level of QoE for a respective application.

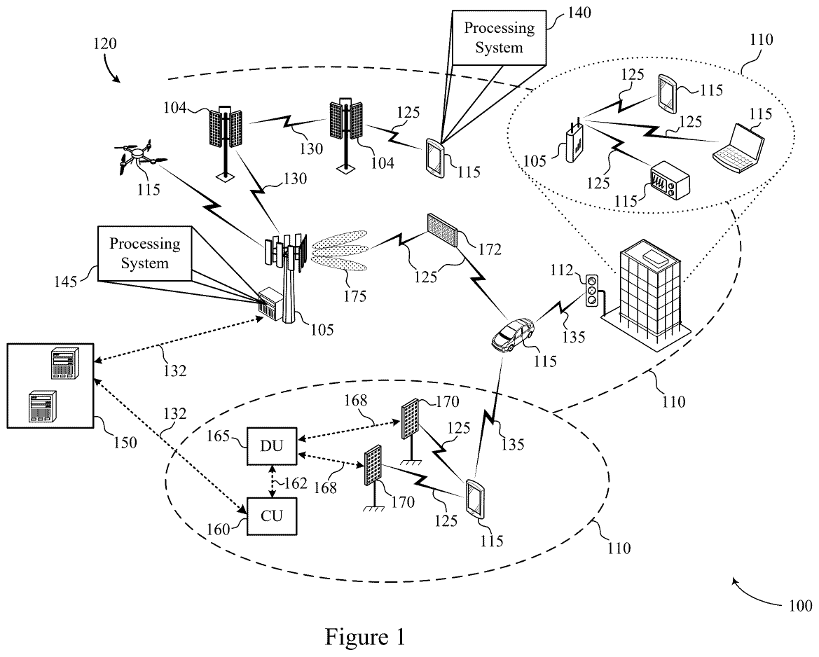

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for recommended bitrate with UX awareness. For example, a UE 115 may include a processing system 140, and a network entity 105 (also referred to herein as a network node or a RAN node) may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support bitrate recommendation and bitrate allocation based on UX. For example, by including QoE information that corresponds to bitrate information in a bitrate recommendation query, the described techniques can be used to efficiently allocate a bitrate to a UE 115 running an application to improve UX for the application. Additionally, by including QoE information that corresponds to bitrate information in a bitrate recommendation query, the described techniques can be used to improve UX for multiple UEs 115 operating respective applications by efficiently allocating bitrate to the multiple UEs based on UX awareness. For example, a network entity 105 allocating bitrates based on UX awareness may allocate a higher bitrate to a first UE 115 operating a complex application and allocate a lower bitrate to a second UE 115 operating a lower complexity application, with each bitrate corresponding to a high level of QoE for a respective application.

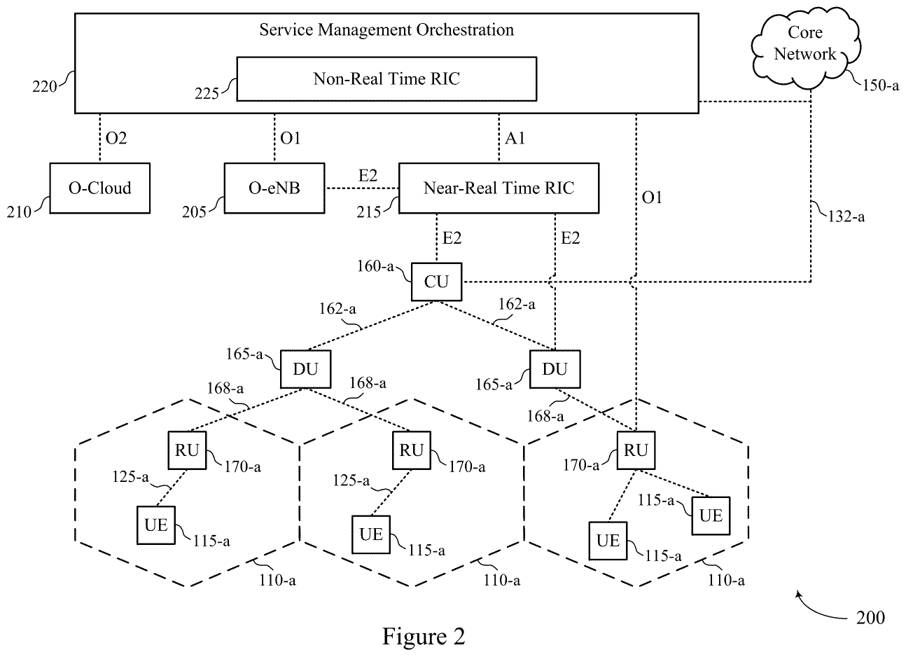

FIG. 2 shows an example of an architecture 200 that supports recommended bitrate with UX awareness. The architecture 200 (such as a network architecture, a disaggregated base station architecture, a disaggregated RAN architecture) illustrates an example for implementing one or more aspects of a communication system 100 (such as a RAN 120), and may include one or more of a CU 160-a, a DU 165-a, and an RU 170-a.

In the example of architecture 200, a CU 160-a may communicate directly with a core network 150-a via a backhaul link 132-a, or indirectly with the core network 150-a through one or more disaggregated network entities 105. A CU 160-a may be connected with a DU 165-a via a midhaul link 162-a (such as an F1, F1c, or F1u interface), and a DU 165-a may be connected with an RU 170-a via fronthaul communication link 168-a (such as an open fronthaul (FH) interface). The RUs 170-a may be associated with respective coverage areas 110-a and may communicate with UEs 115-a via one or more communication links 125-a. A UE 115-a may be served by one or more of an RU 170-a, and multiples of an RU 170-a serving a UE 115-a may be associated with one or more of a DU 165-a.

A split of functionality between one or more of a CU 160-a, a DU 165-a, and an RU 170-a is flexible and may support different functionalities depending on which functions (such as network layer functions, protocol layer functions, baseband functions, RF functions, or combination thereof) are performed at the various entities. For example, a functional split of a protocol stack may be employed such that a CU 160-a, a DU 165-a, and an RU 170-a may each support one or more different layers of the protocol stack. Additionally, or alternatively, a functional split of a protocol stack may be within a protocol layer, such that some functions for a protocol layer are performed by one of a CU 160-a, a DU 165-a, or an RU 170-a, and some other functions of the protocol layer are performed by a different one of the CU 160-a, the DU 165-a, or the RU 170-a.

A CU 160-a may host upper protocol layer (such as layer 3 (L3), layer 2 (L2)) functionality and signaling (such as RRC, SDAP, PDCP). A CU 160-a may be functionally split into CU control plane (CU-CP) and CU user plane (CU-UP) functions. A CU 160-a may be logically split into one or more CU-UP units and one or more CU-CP units. A CU-UP unit may communicate bidirectionally with the CU-CP unit via an interface (such as an E1 interface). A CU 160-a may be connected with one or more of a DU 165-a, one or more of an RU 170-a, or a combination thereof. DUs 165-a, RUs 170-a, or both may host lower protocol layers, which may include layer 1 (L1) (such as PHY layer) or L2 (such as RLC layer, MAC layer) functionality and signaling, and each may be at least partially controlled by a CU 160-a. A DU 165-a may support one or multiple different cells (such as via one or more of an RU 170-a).

The architecture 200 may include a Service Management and Orchestration (SMO) framework (such as implementing an SMO 220) configured to support RAN deployment and provisioning of non-virtualized and virtualized network entities 105. The architecture 200 also may include a RAN Intelligent Controller (RIC), types of which may include Near-Real Time (RT) or Non-RT. In some cases, a network entity 105 (such as a CU 160-a, a DU 165-a) may communicate with a Near-RT RIC 215 via an E2 link, or a Non-RT RIC 225 associated with SMO 220, or both. An RU 170-a also may be referred to as a radio head, a smart radio head, a remote radio head (RRH), a remote radio unit (RRU), or a transmission/reception point (TRP). One or more components of a disaggregated RAN architecture may be co-located, or may be located in distributed (such as separate physical) locations. One or more network entities 105 of a disaggregated RAN architecture may be implemented as virtual units (such as a virtual CU (VCU), a virtual DU (VDU), a virtual RU (VRU)) and provide network function virtualization, which may be supported by an open-cloud (O-Cloud) platform (such as an O-Cloud 210). For example, functionality of a network entity 105 may be implemented in an O-eNB 205.

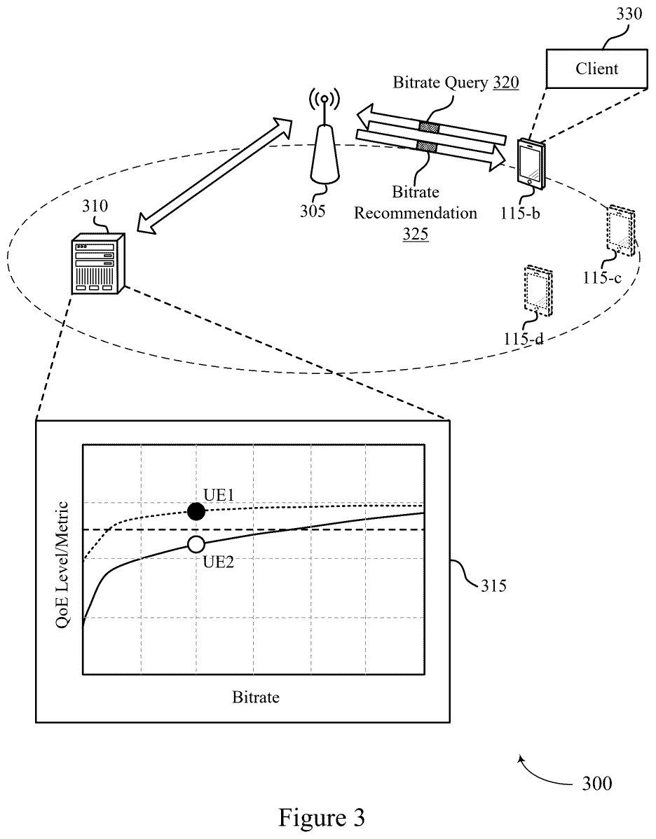

FIG. 3 shows an example of a signaling configuration 300 that supports recommended bitrate with UX awareness. Aspects of the signaling configuration 300 may implement, or be implemented by, aspects of the wireless communications system 100, the architecture 200, or both. For example, the signaling configuration 300 illustrates communication between network devices (such as a RAN node 305 and an application server 310, each of which may be an example of a network entities 105 described with reference to FIG. 1, or other network nodes described with reference to FIG. 1), and UEs 115-b, 115-c, 115-d, each of which may be an example of a UE 115 described with reference to FIG. 1. A RAN node is an example of a network entity discussed herein.

The signaling configuration 300 may support advanced technologies to enable implementation of a cyber-physical network or integrated cyber-physical world, which merges both physical and digital realities. For example, the signaling configuration 300 may support immersive applications such as immersive holographic telepresence with XR, VR, AR, mixed reality, interactive mapping, digital twin and virtual worlds, situational awareness, integration of artificial intelligence and artificial intelligence as a service (AIaaS), among other services. In some aspects, the application server 310 may facilitate or host such XR/VR applications that are executable by the UEs 115, where the RAN node 305 may be used to relay data associated with the XR/VR applications between the UEs 115 and the application server 310. Additionally, or alternatively, a UE 115 may communicate with a client 330 (e.g., an application client) which provides the application, for example via a cross-layer API inside the UE 115. In some examples, the application server 310 may include or host the client 330. In some aspects, immersive applications may utilize high reliability latency-bound (e.g., real-time) video streams with little to no buffering, and high data rates. For such applications and other advanced technologies, it is important to maintaining acceptable levels of UX and QoE, for example, maintaining UX and QoE at or above a quality threshold.

Adaptive rate control (e.g., adaptive bitrate (ABR) control) may be an important feature in multimedia applications, such as XR applications. Current adaptive rate control mechanisms may be based on end-to-end feedback (e.g., feedback between the UEs 115 and the application server 310). End-to-end feedback occurs a slow timescale and does not take QoE into consideration. Such mechanisms may result in large asymmetry in QoE among multiple UEs 115. For example, UEs 115 that are executing applications with simple scene content may consume the same data rate (e.g., bitrate) as compared to UEs 115 with more complex scene content, which may overtake radio resources without actual improvement of UX. By way of another example, UEs 115 in good channel conditions may end up selecting high bitrates (e.g., resulting in unnecessary high QoE), which may cause UEs 115 in worse channel conditions to have very low bitrates (e.g., resulting in low QoE). In some cases, over-the-top ABR algorithms may limit the bitrate in order not to exceed a certain quality, hence, freeing up network resources. Additionally, due to the new development of codecs, some new applications (e.g., new XR/VR applications) may operate at different bitrates and/or different error rate levels, which may be contrasted with the traditional guaranteed bitrate (GBR) vs. non-GBR quality of service (QoS) models.

In some examples, different UEs 115 may have different QoE-bitrate curves due to different inputs or applications executable at the UE 115 (e.g., different scenes, movements, etc.). A UX plot 315 shows an example of QoE levels/metrics (e.g., peak signal-to-noise ratio (PSNR), SNR, or another quality metric) versus bitrate for different UEs 115 (e.g., UE1, UE2). For example, the UE1 and the UE2 may different QoE levels with the same bitrate, such that UE1 has a higher QoE level than UE2 at the same bitrate. In other words, a lower bitrate allocated to UE1 may yield the same QoE level as a higher bitrate allocated to UE2. Additionally, a QoE-bitrate curve at a UE 115 may adapt or change over time, as a scene of an application may become more or less complex over time, such that a consistent bitrate for the application may correspond to a different QoE at different times.

As noted previously herein, the term “QoE level” may refer to a single metric (or a set of metrics) that quantifies the relative QoE/UX that is experienced or observed at a UE. That is, in some cases, a “QoE level” may include a single QoE metric (such as data rate), whereas in other cases, a “QoE level” may be determined based on a combination of multiple QoE metrics. In this regard, a first QoE level may be said to be “higher” or “better” than a second QoE level if at least one metric (e.g., data rate, service quality, latency) associated with the first QoE level exhibits a relatively higher UX as compared to a corresponding metric associated with the second QoE level. For instance, the first QoE level may be said to be “higher” or “better” than the second QoE level if the first QoE level is associated with a higher data rate and/or a lower latency at the UE as compared to the second QoE level.

As shown in the UX plot 315, the QoE level/metric (e.g., UX) for each UE 115 may flatten or saturate as supplied bitrate increases. For example, QoE/UX may increase greatly with increases to a low bitrate but may level off and increase more gradually or flatten as higher bitrates are supplied. In such cases, poor resource distribution among users (based on source unawareness of link conditions and link loading along with QoE unawareness at the RAN node 305) may result in substantial gaps in bitrate assignments to UEs 115 experiencing asymmetric channel conditions.

For example, a first user (e.g., UE1, which may be an example of a UE 115-b) may be assigned excess bitrate (e.g., bitrate that is more than sufficient to obtain a threshold QoE), while the same bitrate supplied to a second user (e.g., UE2, which may be an example of a UE 115-c) may not be sufficient to maintain the same threshold QoE. Poor resource allocation among users may therefore cause inefficiencies in resource distribution while also reducing the QoE for some users within the system. For example, the additional bitrate allocated for the first user (UE1) may be re-allocated to the second user (UE2), which may result in a significant increase in QoE/UX for the second user, while still maintaining a similar UX for the first user.

In some cases, to address the asymmetry in QoE among multiple users, a wireless communications system may support techniques for UX awareness. For example, an application may provide QoE-related information (e.g., QoE-bitrate) curves to the network based on a QoS profile or packet data unit (PDU) set metadata.

Conventional techniques for supplying bitrates to UEs 115 may be a result of the rate-based key performance indicators (KPIs) used in some wireless communications systems, such as 4G and 5G systems. For example, some wireless communications systems may use a GBR scheme for low-latency applications. However, such GBR schemes may not be scalable to large quantities of UEs 115, may result in poor resource utilization due to cell-edge users, and may be expensive for operators (due to the fact that some UEs 115 may be provided excessive bitrates that are “overkill” for achieving some threshold QoE). Comparatively, other wireless systems may implement adaptive rate allocation schemes (e.g., via low latency, low loss, and scalable throughput (L4S)), where the network provides fluctuating data rates and UX. However, such schemes may not guarantee QoE/UX levels, and rate allocation may not take UX into account.

In other words, neither current GBR schemes nor adaptive rate allocation schemes directly take QoE/UX at the UEs 115 into account when allocating bitrates to the UEs 115. That is, with GBR schemes, the network may provide the same GBR (e.g., 5 Mbps) to every UE 115 in the network, and may be unaware of the impact that the resource allocation has on QoE/UX at the respective UEs 115. Moreover, this may lead to inefficient resource allocation that wastes network capacity, and leads to poor UX. For example, depending on the content and channel conditions across the UEs 115, the same 5 Mbps may result in a high QoE/UX at the UE 115-b (e.g., UE1), but may lead to low QoE/UX at the UE 115-c (e.g., UE2). In particular, complex scene content at the UE 115-c (e.g., UE2) may require more resources (e.g., higher bitrate) to satisfy a threshold QoE/UX.

Comparatively, these problems with GBR schemes may be at least partially addressed in cases where the network (such as a 6G network) is aware of the resource allocation impact to QoE/UX. For example, in the example above, a total bitrate of 10 Mbps may be provided to two different UEs 115 (e.g., 5 Mbps to the two different UEs 115). However, if the network is aware of the impact that the respective bitrates have on the QoE/UX at each respective UE 115, the bitrates may be more efficiently allocated across UEs 115 to maintain the threshold QoE/UX, while simultaneously supporting larger quantities of UEs 115. For instance, the same total bitrate of 10 Mbps may be allocated across three different UEs 115 (e.g., UE1→6 Mbps, UE2→1 Mbps, UE3→3 Mbps), where UEs 115 with more complex content (e.g., UE1) can be allocated higher bitrates to achieve a threshold QoE/UX, and where UEs 115 with less complex content (e.g., UE2, UE3) may be allocated lower bitrates to achieve the same threshold QoE/UX. Thus, techniques described herein for network-aware QoE/UX impact may lead to a more efficient use of resources, improved QoE/UX, and higher capacity (e.g., more supported users).

To summarize, issues with conventional techniques for allocating bitrates across UEs 115 may be broken down into several observations/characteristics. First, UX as a function of bitrate (as shown in the UX plot 315) may be different for different users and may depend on scene content and codec. That is, stored videos (e.g., AR/VR applications) may be encoded with different modes/profiles and may exhibit various scene complexity and codecs. Second, QoE/UX flattens/saturates as bitrate increases (as shown in flattening curves with higher bitrates in the UX plot 315). Third, scene content can vary over time (even at the same UE 115), and so the QoE/UX-to-bitrate function may also vary over time. That is, the QoE-to-bitrate curve for UE1 may change over time as the scene content for an AR/VR application at UE1 changes over time. Fourth, UX-unaware rate allocation mechanisms in some networks (e.g., 5G networks) may not be able to guarantee a minimum QoE/UX threshold across users, and the number of simultaneous users meeting a UX threshold (capacity) may not be maximized.

In some wireless communications systems, a UE 115 and a network entity 105 may support bitrate recommendation for fast and reliable bitrate adaptation. Bitrate recommendation may include two stages of signaling. For a first stage, a UE 115 may transmit a bitrate recommendation query to a network entity 105. For example, in the first stage, the UE 115 may send a desired or request bitrate to the network entity 105. For a second stage, the network entity 105 may transmit a bitrate recommendation to the UE 115. For example, the network entity 105 may transmit the recommended bitrate to the UE 115, for example based on information of the bitrate recommendation query.

Bitrate recommendation may be communicated via a MAC CE or other control message. For example, the UE 115 may transmit a first MAC CE including a bitrate recommendation query to request or indicate a desired bitrate. The network entity 105 may transmit a second MAC CE including a bitrate recommendation to indicate the recommended bitrate. The bitrate recommendation query or the bitrate recommendation, or both, may include a logical channel identifier, an indication of a flow direction (e.g., uplink or downlink), a bitrate, and a bitrate multiplier. For example, a bitrate field in the bitrate recommendation query (e.g., from UE 115 to network) may correspond to a requested or desired bitrate, and a bitrate field in the bitrate recommendation (e.g., from network to UE 115) may correspond to a recommended bitrate.

Current techniques for bitrate recommendation can only support a single bitrate per logical channel. Additionally, current techniques for bitrate recommendation do not consider UX for bitrate adaptation. Current techniques for bitrate recommendation may support only a semi-static averaging window.

Techniques described herein support bitrate recommendation based on UX awareness. For example, a UE 115, such as the UE 115-b, may transmit, to the RAN node 305, a first message including a bitrate query 320 that includes bitrate query information based on UX awareness. The bitrate query 320 may be an example of a bitrate recommendation query that is associated with UX awareness or an enhanced bitrate recommendation query. For example, the bitrate query 320 may include aspects of a bitrate recommendation query and be enhanced to include information based on UX awareness. The RAN node 305 may transmit a second message including a bitrate recommendation 325 that includes bitrate recommendation information based on UX awareness and/or the bitrate query 320.

The bitrate query 320 may include information based on UX awareness, such as based on a QoE-bitrate curve. For example, the UE 115-b may send (e.g., via the bitrate query 320) a type of QoE according to an application at the UE 115-b, such as video, audio, haptic, or IoT. The UE 115-b may send a time window during which the bitrate query 320, or parameters of the bitrate query 320, is valid. The UE 115-b may send a quantity of listed bitrates and corresponding QoE values, which may indicate to the RAN node 305 a size of the bitrate query 320. The UE 115-b may provide a list of supportable bitrates and corresponding, relevant QoE levels. In some examples, the UE 115-b may provide multiple QoEs according to a certain bitrate (e.g., video quality, latency, power consumption, etc.). In some examples, to reduce a quantity of bits, the UE 115-b may delta bitrate or delta QoE information for multiple bitrates and QoEs.

For example, the bitrate query 320 may indicate a list of one or more supportable points in a QoE-bitrate curve to the RAN node 305. For example, the bitrate query 320 may indicate a first bitrate and a first QoE (e.g., QoE level or value for a QoE metric) that corresponds to the first bitrate for an application. If the UE 115-b is allocated with the first bitrate for the application, UX for the application at the UE 115-b may correspond to the first QoE. The UE 115-b may provide multiple candidate bitrates with corresponding QoEs (e.g., points in the QoE-bitrate curve supported by the UE 115-b). In some examples, the UE 115-b may indicate an N-bit quantization of the points of the QoE-bitrate curve instead of indicating all points of the QoE-bitrate curve.

In some examples, the application may provide the supportable points in a QoE-bitrate curve to a UE 115, such as the UE 115-b. For example, with cross-layer API, the application (e.g., operating via the client 330 or the application server 310) may provide the related information (e.g., the QoE-bitrate curve or points of the QoE-bitrate curve) to the UE 115-b. For uplink information (e.g., uplink video), the encoder may be placed at the client 330. For example, the client 330 may directly send the QoE-bitrate curve to the UE 115-b. For downlink information (e.g., video), the encoder may be placed at the application server 310 or another client. In some examples, the application server 310 or the other client may send the QoE-bitrate curve to the client 330, and the client 330 may forward the QoE-bitrate curve to the UE 115-b. Additionally, or alternatively, the client 330 may estimate the QoE-bitrate curve, such as by an algorithm, statistics, prediction techniques, artificial intelligence, machine learning techniques, or any combination thereof.

In some examples, the UE 115-b may list the points in the QoE-bitrate bitrate query 320 based on a priority. For example, a first bitrate and a first QoE level at a top or beginning of a list of bitrates and QoE levels in the QoE-bitrate bitrate query 320 may correspond to a highest priority, and a last bitrate and last QoE level in the list in the QoE-bitrate bitrate query 320 may correspond to a lowest priority. The priority may, in some examples, be determined by the UE 115-b. In other words, the list in the QoE-bitrate bitrate query 320 may include associate a priority level (e.g., from top to bottom) based on an order of bitrates and corresponding QoE levels.

In some examples, a bitrate indicated via the bitrate query 320 may be defined per frame, PDU burst, PDU set, per time window, or any combination thereof. In some examples, a bitrate indicated by the bitrate query 320 may correspond to a desired (e.g., requested) maximum bitrate for a time window or a desired (e.g., requested) average bitrate for the time window (e.g., requested or recommended in the QoE-bitrate bitrate query 320).

The UE 115-b may provide (e.g., via the bitrate query 320) a QoE metric for each supportable bitrate indicated by the bitrate query 320. For example, for XR video traffic, the QoE metric may be PSNR or video multimethod assessment fusion (VMAF), or both. Additionally, or alternatively, different types of QoE metrics may be provided for UX awareness. For example, the bitrate query 320 may indicate a latency metric or a power consumption metric, or both. In some examples, the bitrate query 320 may indicate multiple QoE metrics (e.g., UX metrics) for one or more bitrates. Additionally, or alternatively, other services, applications, or QoEs may have different QoE metrics. For example, URLLC may have a QoE metric corresponding to latency or reliability, or both. IoT applications or services, such as industrial IoT (IIoT) applications or services, may use power consumption for a QoE metric. A wireless communications system may configure a QoE metric for a specific QoS flow or LCID, or both. In some examples, the bitrate query 320 may support multiple recommended bitrates for multiple QoS flows.

In some examples, the bitrate query 320 may indicate delta information between bitrates or QoE levels, or both. For example, the bitrate query 320 may indicate a first bitrate, a first QoE level for an application at the first bitrate, or both. The bitrate query 320 may indicate a second bitrate, a second QoE level, or both, by including a difference between the first bitrate and the second bitrate, by including a difference between the first QoE level and the second QoE level, or both. For example, the bitrate query 320 may include a first field to indicate the first bitrate, and the first field may indicate a value corresponding to 5 Mbps. The bitrate query 320 may include a second field to indicate a second bitrate of 6 Mbps, and the second field may indicate a value corresponding to 1 Mbps (e.g., such that the second bitrate is 1 Mbps higher than the first bitrate). Indicating delta information or the difference between the first bitrate and the second bitrate (e.g., instead of indicating the full value of the second bitrate) may reduce overhead for the bitrate query 320. If the bitrate query 320 includes multiple bitrates and corresponding QoE levels (e.g., three or more bitrates and corresponding QoE levels), the delta information may be with respect to a first value or a previous value. For example, a third bitrate may be indicated by the bitrate query 320 including delta information with reference to the first bitrate or delta information with reference to the second bitrate. These techniques may be implemented for other protocols that are implemented in accordance with UX awareness, such as indicating PDU set metadata over a user plane or QoS profiles that are based on UX awareness.

In some examples, the UE 115-b may indicate a time window (e.g., duration) during which the QoE-bitrate mapping is valid. For example, the bitrate query 320 may include a field indicating a duration, during which the information of the bitrate query 320 is valid. The UE 115-b may specify the time window to ensure consistency of the QoE-bitrate information. During the time window, the RAN node 305 may preserve resources for the UE 115-b and use remaining resources for other UEs 115. If a bitrate (e.g., a QoE-bitrate curve) changes slowly at the UE 115-b, the UE 115-b may indicate a longer time window. In some examples, the time window may be defined by a time unit. For example, the UE 115-b may indicate a quantity of milliseconds for which the information of the bitrate query 320 is valid. Additionally, or alternatively, the bitrate query 320 may indicate, for example, a quantity of video frames, quantity of PDU sets, quantity of bursts (e.g., PDU bursts), or any combination thereof, for the time window. In some examples, the bitrate query 320 may indicate an integer multiple of a frame periodicity for video. In some examples, an integer multiple having a value of 0 may indicate no predicted time window. In some examples, with cross-layer API, the application may provide the related information to the UE 115-b. For example, the client 330 may provide information associated with the QoE-bitrate curve, such as time variations for the QoE-bitrate curve, to the UE 115-b. Additionally, or alternatively, the application may indicate a time window associated with a specific QoE-bitrate curve to the UE 115-b during which the UE 115-b is to recommend or follow a set point on the specific QoE-bitrate curve, a recommended bit rate on the specific QoE-bitrate curve, or both.

The RAN node 305 may transmit the bitrate recommendation 325 which specifies a time window during which the UE 115-b is to follow the recommended bitrate. For example, the UE 115-b may transmit the bitrate query 320 indicating points of a QoE-bitrate curve and a time window during which the points of the QoE-bitrate curve are valid. The RAN node 305 may transmit the bitrate recommendation 325 indicating a bitrate, in some cases based on the information of the bitrate query 320, and a time window during which the UE 115-b is allocated the bitrate (e.g., should follow the recommended bitrate).

By considering the QoE impacts across all users (e.g., UEs 115) in a cell, a network entity, such as the RAN node 305, may select a bitrate for one or more or each UE 115 and indicate the recommended bitrates to the UEs 115 via a bitrate recommendation 325 (e.g., in a control message or control signal). For example, the RAN node 305 may receive the bitrate query 320 from the UE 115-b, and the RAN node 305 may indicate bitrate recommendations to the UE 115-b, the UE 115-c, and the UE 115-d based on the bitrate query information. Additionally, or alternatively, the RAN node 305 may receive bitrate query information from the UE 115-c and the UE 115-d and allocate bitrates to the UEs 115 based on bitrate query information from multiple UEs 115.

For example, the RAN node 305 may receive the bitrate query 320 from the UE 115-b and transmit a bitrate recommendation 325 to the UE 115-b based on the information of the bitrate query 320. In some examples, the bitrate recommendation 325 may indicate one of the candidate bitrates indicated by the bitrate query 320. In some examples, the bitrate recommendation 325 may indicate a bitrate based on the candidate bitrates indicated by the bitrate query 320. For example, the RAN node 305 may determine a recommended bitrate that is between two candidate bitrates indicated by the bitrate query 320. In some examples, the bitrate recommendation 325 may indicate a QoE level or an index (e.g., to a candidate bit rate from the set of candidate bitrates). As described herein, the bitrate recommendation 325 may indicate a time window during which the UE 115-b is to use the recommended bitrate. The recommended bitrate may be defined per frame or per time window. The bitrate may correspond to a maximum allowed bitrate in the time window or an average bitrate (e.g., an average allowed bitrate) in the time window. The UE 115-b may not be permitted to exceed the bitrate specified in the bitrate recommendation 325. In some cases, the RAN node 305 may update the bitrate (e.g., at any time) to adjust the overall bitrates in the cell (e.g., for a UE requiring a higher bitrate scene, a new UE in the cell).

In some examples, the network may configure a UE 115 with at least one criterion for recommended bitrate query updating. For example, if a bitrate is changed more than a threshold percentage (e.g., based on a scene change), the UE 115 may transmit another recommended bitrate query (e.g., an update for the bitrate query 320). That is, the UE 115 may transmit an updated bitrate query, which may indicate one or more new points of a QoE-bitrate curve requested as an updated bitrate. In some examples, the QoE-bitrate curve for an application may change over time, such that a same bitrate corresponds to a different QoE level. For example, the curve may change such that the same bitrate provides an unsuitable QoE level (e.g., too high or too low of a QoE level).

For example, the RAN node 305 may transmit control signaling to the UE 115-b indicating a configuration for transmitting a bitrate query update. The configuration for transmitting the bitrate query update may include at least one criterion for transmitting another bitrate query or when the UE 115-b is to report a supportable bitrate and QoE to the RAN node 305. In some examples, the UE 115-b may be configured to provide periodic updates. For example, the UE 115-b may transmit the bitrate query 320 periodically. The UE 115-b may be triggered to transmit the bitrate query 320 based on an event-driven trigger. For example, if the UE 115-b detects a bitrate change (e.g., if bitrate is changed more than a certain threshold), a QoE change (e.g., if QoE is changed more than a certain threshold), a time window change (e.g., a time window is updated more than a certain threshold), a scene change, or any combination thereof, the UE 115-b may transmit a bitrate query update (e.g., another bitrate query to request an updated bit rate). In some examples, the configuration for transmitting the bitrate query update may indicate thresholds for one or more event-driven triggers. In some examples, the control signaling to indicate the configuration may be RRC signaling. In some examples, the RAN node 305 may transmit a MAC CE to update the at least one criterion (e.g., one or more parameters of the configuration for transmitting the bitrate query update).

In some examples, the network may indicate a configuration for the bitrate query 320 to a UE 115. For example, the RAN node 305 may indicate a configuration for the bitrate query 320 to the UE 115-b. The RAN node 305 may send a QoS flow, range, granularity, and time window for recommended bitrate query reporting. For example, if an application can support a large quantity of points in a QoE-bitrate curve, reporting too many points of the curve may waste resources of control signaling from the UE 115-b to the network. The RAN node 305 may configure the UE 115-b with one or more QoS flows or one or more data radio bearers (DRBs) and QoE metrics for recommended bitrate query reporting. For example, the RAN node 305 may configure the UE 115-b to transmit the bitrate query 320 for QoE metrics based on signal-to-quantization-noise ratio (SQNR), latency, power consumption, or any combination thereof.

In some examples, the RAN node 305 may configure the UE 115-b with a range for RBR query reporting. For example, the RAN node 305 may configure the UE 115-b with a range of QoE levels and/or bitrates (e.g., indicating a minimum or maximum, or both, for QoE levels and/or bitrates). Configuring a range for the bitrate or QoE levels may prevent the UE 115-b from reporting too wide of a range in the QoE-bitrate curve, reducing control signaling overhead.

In some examples, the RAN node 305 may configure (e.g., via control signaling) the UE 115-b with a granularity for recommended bitrate query reporting. For example, the UE 115-b may be configured with a granularity for reporting QoE levels or bitrates, or both. For example, the RAN node 305 may configure a minimum QoE granularity, a maximum QoE, a minimum bitrate granularity, a maximum bitrate, or any combination thereof. In some examples, the RAN node 305 may configure the UE 115-b with a desired time window for recommended bitrate query reporting. The term configure may refer herein to exchanging one or more control signals or control messages. In an example, the RAN node 305 may configure the UE 115-b with a minimum time window to be reported in the bitrate query 320. In some examples, the UE 115-b may provide the configuration to the application, for example via a cross-layer API inside the UE 115-b. In some examples, the RAN node 305 may transmit control signaling, such as RRC signaling, to indicate the configuration for the bitrate query 320 (e.g., range and granularity information for the bitrate query 320). Additionally, or alternatively, the RAN node 305 may indicate range information or granularity information, or both, for the bitrate query 320 via a MAC CE (e.g., the bitrate recommendation 325).

In some examples, the UE 115-b may send capability information associated with UX awareness to the RAN node 305. For example, the UE 115-b may send a UE capability message indicating that the UE 115-b can support enhanced bitrate recommendation (e.g., the UE 115-b is capable of transmitting the bitrate query 320 based on UX awareness). In some examples, the capability information may indicate whether the UE 115-b supports a QoE report (e.g., a bitrate query 320) for a specific QoS flow or DRB, or both. In some examples, an application may indicate to the UE 115-b whether the application can support a QoE report (e.g., a bitrate query 320) for a specific QoS flow or DRB, or both (e.g., via an interface between an application function and a network exposure function (NEF)). Additionally, or alternatively, the application server 310 may indicate (e.g., to the UE 115-b) whether the application server 310 can support a QoE report (e.g., a bitrate query 320) for a specific QoS flow or DRB, or both. In some examples, the RAN node 305 may enable (or disable) the UE 115-b to perform QoE reporting for a specific QoS flow or DRB, or both. For example, the RAN node 305 may transmit, to the UE 115-b, control signaling (e.g., RRC signaling) that indicates a configuration for QoE reporting and may transmit, to the UE 115-b, a second control message (e.g., MAC CE, DCI), to activate or deactivate QoE reporting in accordance with the configuration.

The signaling configuration 300 may support additional network protocol messages to enable recommended bitrate techniques based on UX awareness. For example, a policy control function (PCF) may define which QoS flows support recommended bitrate techniques with UX awareness (e.g., via a 5-tuple traffic flow template (TFT)). Additionally, or alternatively, an application function may request for a specific QoS flow to support recommended bitrate techniques with UX awareness. A session management function (SMF) may consider UX awareness for a service data flow (SDF) binding. In some examples, the network may enable recommended bitrate techniques with UX awareness using a QoE report (e.g., a bitrate query 320 or a bitrate recommendation 325 based on UX awareness, or both) for a specific QoS flow or DRB. In some examples, the network may prioritize users providing a recommended bitrate via the bitrate query 320 based on UX awareness more than other users. For example, the network (e.g., RAN node or other network entity) may guarantee a minimum QoE for a user (e.g., a UE 115) that supports UX awareness or allocate a bitrate to the user with a higher priority in cases of network congestion.

Bitrate recommendation based on UX awareness may be implemented for video streams, audio streams, haptic streams, or other types of applications. For example, these techniques may be implemented to recommend a bitrate to achieve a QoE level for audio quality. UX awareness may include additional aspects, such as service quality, power consumption, latency, and performance. In some examples, a centralized node may select a QoS profile for a UE 115, such as a UX controller. These techniques may enable UX awareness for the signaling configuration 300, improving QoE for the UEs 115 by allocating bitrates to the UEs 115 based on QoE levels.

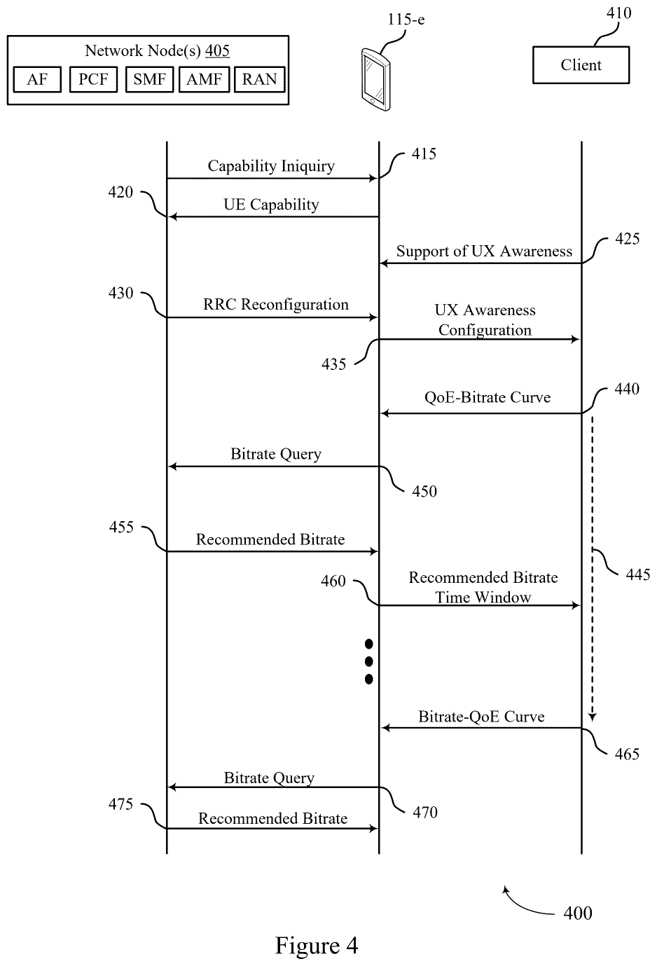

FIG. 4 shows an example of a process flow 400 that supports recommended bitrate with UX awareness. The process flow 400 may implement, or be implemented by, aspects of the wireless communications system 100, the architecture 200, the signaling configuration 300, or any combination thereof.

For example, the process flow 400 may illustrate a communications flow or call flow between a UE 115-e, one or more network nodes 405, and a client 410, which may be examples of the corresponding devices as described with reference to FIGS. 1-4. The network nodes 405 shown and described in FIG. 4 may be examples of the RAN node 305 described with reference to FIG. 3 and/or other network nodes (e.g., an application function, a PCF, an SMF, an AMF, a RAN, a UPF, or any combination thereof).

The client 410 described with reference to FIG. 4 may be an example of the application server 310 illustrated in FIG. 3 or a client as described with reference to FIG. 3. In some examples, the UE 115-e may operate an application via the client 410. In some examples, the UE 115-e and the client 410 may communicate via a cross-layer API inside the UE 115-e.

In the following description of the process flow 400, the operations between the UE 115-d, the network nodes 405, and the client 410 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 415, the UE 115-e may receive a capability inquiry from one or more of the network nodes 405 (e.g., a RAN node). In some examples, at 420, the UE 115-e may transmit a capability message indicating UE capability information of the UE 115-e. For example, the UE 115-e may indicate support for bitrate recommendation with UX awareness. In some examples, at 425, the client 410 may indicate support of UX awareness to the UE 115-e. For example, at 425, the client 410 may indicate whether an application of the client 410 can support bitrate recommendation based on UX awareness, such as for a specific QoS flow or DRB. In some cases, the AF and the PCT of the network nodes may establish an AF session with a defined QoS (e.g., required QoS) for managing a QoS flow for UX awareness, based on the capability information reported by the UE 115-e. Additionally, the PCF, the SMF, and AMF, and a RAN node (e.g., network nodes or network entities) may exchange signaling for QoS Session Management for managing a QoS flow for UX awareness based on the capability information reported by the UE 115-e.

In some examples, the network nodes 405 may send an RRC configuration (e.g., an RRC reconfiguration) to the UE 115-e. For example, the network nodes 405 may transmit, and the UE 115-e may receive, configuration information associated with bitrate query information. The network nodes 405 may indicate configuration information for communicating a recommended bitrate based on UX awareness.

In some examples, the configuration information may include one or more QoS flows or one or more DRBs support or are enabled for recommended bitrate query reporting (e.g., based on UX awareness). In some examples, the configuration information may include a reporting range for the bitrate query. In some examples, the configuration information may include a reporting granularity for the bitrate query. In some examples, the configuration information may include reporting criteria for the bitrate query. For example, the configuration information may indicate one or more QoS flows, one or more QoE metric identifiers, one or more threshold QoE metrics, one or more threshold bitrates, a QoE metric granularity, a bitrate granularity, a threshold duration associated with the bitrate query information, or any combination thereof. In some examples, the configuration information may include a threshold time window duration (e.g., a minimum time window) for the bitrate query. In some examples, the UE 115-e may send the configuration information (e.g., UX awareness configuration) to the client 410.

In some examples, the configuration information may be associated with updating bitrate query information or updating a recommended bitrate based on UX awareness. For example, the configuration information may indicate a periodicity associated with transmission of the bitrate query information, trigger information associated with transmission of the bitrate query information, threshold information associated with transmission of the bitrate query information, or any combination thereof. At 435, the UE 115-e may forward the UX awareness configuration to the client 410. The UX awareness configuration may indicate at least one criterion for sending a bit rate query (e.g., query 320) for requesting an updated bitrate query as well as QoS flow, range, granularity and time window for query reporting, as discussed herein.

At 440, the client 410 may send information of a QoE-bitrate curve to the UE 115-e. In some examples, the client 410 may indicate points of a QoE-bitrate curve for an application to the UE 115-e. For example, the client may indicate one or more QoE levels that correspond to one or more bitrates for the application. In some examples, the client 410 may indicate time window information associated with the QoE-bitrate curve to the UE 115-e. For example, the client 410 may indicate a time window 445 during which the QoE-bitrate curve information is valid.

At 450, the UE 115-e may transmit a first message including bitrate query information associated with an application. For example, the UE 115-e may transmit a recommended bitrate query associated with UX awareness. In some examples, the bitrate query information may indicate a QoS flow or a DRB. In some examples, the bitrate query information may include a list of one or more bitrates. The bitrate query information may indicate QoE levels associated with the list of one or more bitrates. For example, the bitrate query information may indicate one or more QoE metrics and one or more bitrates that correspond to the one or more QoE metrics. In some examples, the bitrate query information may indicate points of a QoE-bitrate curve for the application. In some examples, the bitrate query information may indicate the time window 445 (e.g., a length of the time window 445 or an end time of the time window 445).

At 455, the network nodes 405 may transmit an indication of a recommended bitrate to the UE 115-e based on the bitrate query information. For example, the network nodes 405 may transmit, and the UE 115-e may receive, a second message including bitrate information associated with the application based on the bitrate query information. The bitrate information may include an indication of a QoS flow or a DRB associated with the bitrate information. In some examples, the bitrate information may include a recommended bitrate (e.g., for the QoS flow, DRB, or the application). In some examples, the bitrate information may indicate a time window associated with the bitrate information. For example, the bitrate information may include a time window, during which the UE 115-e is to use the recommended bitrate for the application. In some examples, the first message, the second message, or both, may be enhanced from a MAC-CE command of recommended bit rate (RBR). At 460, the UE 115-e may send the recommended bitrate information, including the recommended bitrate time window, to the client 410.

The UE 115-e may communicate data for the application in accordance with the bitrate information. For example, the UE 115-e may communicate the data for the application during the time window in accordance with the bitrate information. In some examples, the UE 115-e may transmit data for the application according to the recommended bitrate, or the UE 115-e may receive data for the application according to the recommended bitrate, or both.

In some examples, the UE 115-e may send updated bitrate query information. For example, at 465, the client 410 may send QoE-bitrate curve information to the UE 115-e. In some examples, the QoE-bitrate curve information sent at 440 may be expired or invalid after an expiration of the time window 445. The client 410 may send updated QoE-bitrate curve information after expiration of the time window 445. At 470, the UE 115-e may send another bitrate query to the network nodes 405, which may indicate points of the updated QoE-bitrate curve. At 475, the network nodes 405 may transmit recommended bitrate information (e.g., updated recommended bitrate information) to the UE 115-e based on the updated bitrate query information. In some examples, the updated recommended bitrate information may indicate another recommended bitrate time window, and the UE 115-e may indicate the recommended bitrate time window to the client 410.

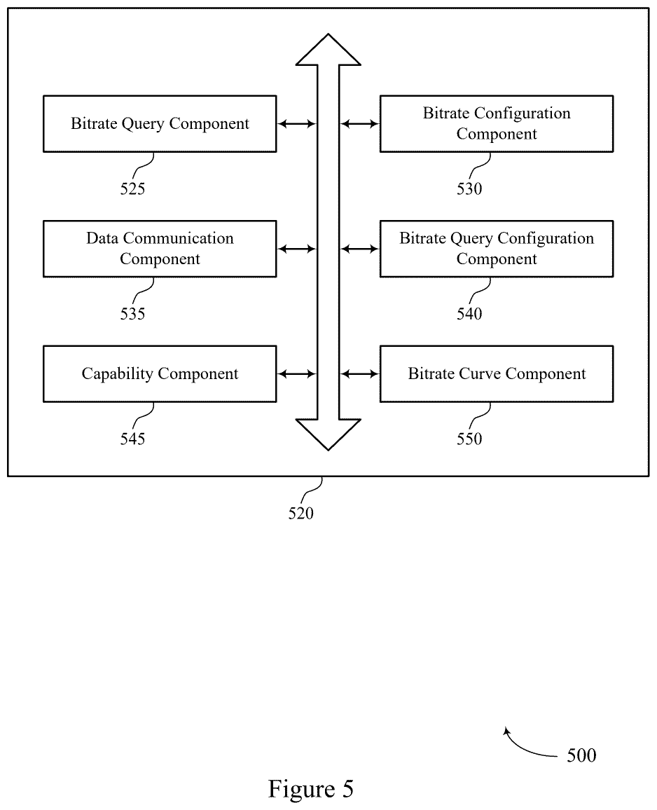

FIG. 5 shows an example of a processing system 520 that supports recommended bitrate with UX awareness. A processing system 520 may be an example of a processing system 140 (such as of a UE 115) and may include a bitrate query component 525, a bitrate configuration component 530, a data communication component 535, a bitrate query configuration component 540, a capability component 545, a bitrate curve component 550, or any combination thereof. A processing system 520, or various component thereof, may be an example of means for performing (such as a means for causing a UE 115 to perform) various techniques described herein.

The bitrate query component 525 may be configured to cause the UE 115 to transmit a first message including bitrate query information associated with an application, the bitrate query information indicating one or more QoE metrics and one or more bitrates that correspond to the one or more QoE metrics. The bitrate configuration component 530 may be configured to cause the UE 115 to receive a second message including bitrate information associated with the application based on the bitrate query information. The data communication component 535 may be configured to cause the UE 115 to communicate data for the application in accordance with the bitrate information.

In some examples, to support transmitting the first message, the bitrate query component 525 may be configured to cause the UE 115 to transmit the first message including the bitrate query information that indicates a set of multiple QoE metrics of a QoE-bitrate curve associated with the application and a set of multiple bitrates of the QoE-bitrate curve that correspond to the set of multiple QoE metrics.

In some examples, the bitrate curve component 550 may be configured to cause the UE 115 to obtain the QoE-bitrate curve from an application server associated with the application.

In some examples, an order of the set of multiple QoE metrics and the set of multiple bitrates in the bitrate query information is based on a priority associated with one or more of the set of multiple QoE metrics, a priority associated with one or more of the set of multiple bitrates, or both.

In some examples, to support transmitting the first message, the bitrate query component 525 may be configured to cause the UE 115 to transmit the first message including the bitrate query information that indicates the one or more bitrates in the bitrate query information corresponding to one or more maximum bitrates, one or more requested bitrates, one or more average bitrates, or any combination thereof.

In some examples, to support transmitting the first message, the bitrate query component 525 may be configured to cause the UE 115 to transmit the first message including the bitrate query information that indicates the one or more QoE metrics including a peak signal-to-noise ratio, a video multimethod assessment fusion metric, a latency metric, a power consumption metric, a reliability metric, or any combination thereof.

In some examples, the bitrate query information includes one or more logical channel identifiers, one or more Quality of Service flow identifiers, or any combination thereof, associated with the data for the application.

In some examples, the bitrate query information includes a first bitrate and one or more delta bitrates based on the first bitrate, or the bitrate query information includes a first QoE metric and one or more delta QoE metrics based on the first QoE metric, or both.

In some examples, to support communicating the data for the application, the data communication component 535 may be configured to cause the UE 115 to communicate the data for the application according to the bitrate information for a duration based on the bitrate query information.

In some examples, the duration corresponds to a quantity of time, a quantity of PDU sets, a quantity of PDU bursts, a quantity of video frames, or any combination thereof.

In some examples, the duration is based on a duration indicated by the bitrate query information.

In some examples, the bitrate information in the second message indicates a first bitrate from the one or more bitrates indicated by the first message or a second bitrate that is based on the one or more bitrates.

In some examples, the bitrate information in the second message indicates a QoE metric of the one or more QoE metrics or an index of the one or more QoE metrics.

In some examples, the bitrate query configuration component 540 may be configured to cause the UE 115 to receive configuration information associated with the bitrate query information, the configuration information including a periodicity associated with transmission of the bitrate query information, trigger information associated with transmission of the bitrate query information, threshold information associated with transmission of the bitrate query information, or any combination thereof.

In some examples, the bitrate query configuration component 540 may be configured to cause the UE 115 to receive configuration information associated with the bitrate query information, the configuration information indicating one or more QoS flows, one or more QoE metric identifiers, one or more threshold QoE metrics, one or more threshold bitrates, a QoE metric granularity, a bitrate granularity, a threshold duration associated with the bitrate query information, or any combination thereof.

In some examples, the capability component 545 may be configured to cause the UE 115 to transmit capability information associated with the bitrate query information, the capability information indicating support for transmission of the bitrate query information, one or more QoS flows associated with the bitrate query information, or any combination thereof.

In some examples, the one or more QoE metrics include video quality, audio quality, haptic quality, power consumption, battery life, latency, reliability, or any combination thereof; and the application is a multimedia application, a URLLC application, an IoT application, or any combination thereof.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for reduced processing, reduced power consumption, and more efficient utilization of communication resources.

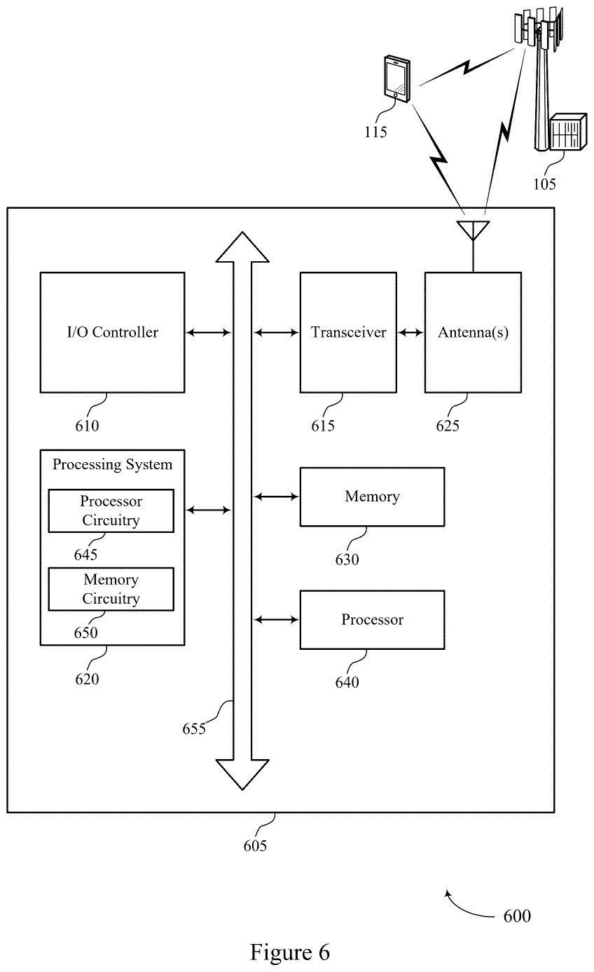

FIG. 6 shows an example of a system 600 including a device 605 that supports recommended bitrate with UX awareness. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support recommended bitrate with UX awareness. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved communication reliability, reduced latency, improved UX, reduced power consumption, more efficient utilization of communication resources, improved coordination between devices, and longer battery life.

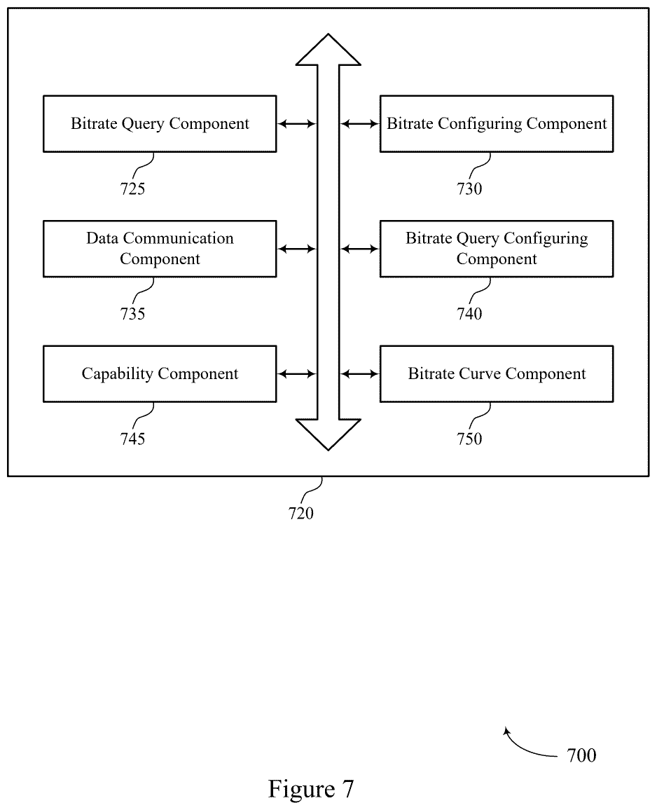

FIG. 7 shows an example of a processing system 720 that supports recommended bitrate with UX awareness. A processing system 720 may be an example of a processing system 145 (such as network entity 105) and may include a bitrate query component 725, a bitrate configuring component 730, a data communication component 735, a bitrate query configuring component 740, a capability component 745, a bitrate curve component 750, or any combination thereof. A processing system 720, or various component thereof, may be an example of means for performing (such as a means for causing a network entity 105 to perform) various techniques described herein.

The bitrate query component 725 may be configured to cause the network entity 105 to obtain a first message including bitrate query information associated with an application at a UE, the bitrate query information indicating one or more QoE metrics and one or more bitrates that correspond to the one or more QoE metrics. The bitrate configuring component 730 may be configured to cause the network entity 105 to output a second message including bitrate information associated with the application at the UE based on the bitrate query information. The data communication component 735 may be configured to cause the network entity 105 to communicate data for the application in accordance with the bitrate information.

In some examples, the bitrate query information indicates a set of multiple QoE metrics of a QoE-bitrate curve associated with the application and a set of multiple bitrates of the QoE-bitrate curve that correspond to the set of multiple QoE metrics.

In some examples, the bitrate curve component 750 may be configured to cause the network entity 105 to output the QoE-bitrate curve to an application server associated with the application.

In some examples, an order of the set of multiple QoE metrics and the set of multiple bitrates in the bitrate query information is based on a priority associated with one or more of the set of multiple QoE metrics, a priority associated with one or more of the set of multiple bitrates, or both.

In some examples, the one or more bitrates in the bitrate query information correspond to one or more maximum bitrates, one or more requested bitrates, one or more average bitrates, or any combination thereof.

In some examples, the one or more QoE metrics include a peak signal-to-noise ratio, a video multimethod assessment fusion metric, a latency metric, a power consumption metric, a reliability metric, or any combination thereof.

In some examples, the bitrate query information includes one or more logical channel identifiers, one or more Quality of Service flow identifiers, or any combination thereof, associated with the data for the application.

In some examples, the bitrate query information includes a first bitrate and one or more delta bitrates based on the first bitrate, or the bitrate query information includes a first QoE metric and one or more delta QoE metrics based on the first QoE metric, or both.

In some examples, to support communicating the data for the application, the data communication component 735 may be configured to cause the network entity 105 to communicate the data for the application according to the bitrate for a duration based on the bitrate query information.

In some examples, the duration corresponds to a quantity of time, a quantity of PDU sets, a quantity of PDU bursts, a quantity of video frames, or any combination thereof.

In some examples, the duration is based on a duration indicated by the bitrate query information.

In some examples, the bitrate information in the second message indicates a first bitrate from the one or more bitrates indicated by the first message or a second bitrate that is based on the one or more bitrates.

In some examples, the bitrate information in the second message indicates a QoE metric of the one or more QoE metrics or an index of the one or more QoE metrics.

In some examples, the bitrate query configuring component 740 may be configured to cause the network entity 105 to output configuration information associated with the bitrate query information, the configuration information including a periodicity associated with transmission of the bitrate query information, trigger information associated with transmission of the bitrate query information, threshold information associated with transmission of the bitrate query information, or any combination thereof.

In some examples, the bitrate query configuring component 740 may be configured to cause the network entity 105 to output configuration information associated with the bitrate query information, the configuration information indicating one or more QoS flows, one or more QoE metric identifiers, one or more threshold QoE metrics, one or more threshold bitrates, a QoE metric granularity, a bitrate granularity, a threshold duration associated with the bitrate query information, or any combination thereof.

In some examples, the capability component 745 may be configured to cause the network entity 105 to obtain capability information associated with the bitrate query information, the capability information indicating support for transmission of the bitrate query information, one or more QoS flows associated with the bitrate query information, or any combination thereof.

In some examples, the one or more QoE metrics include video quality, audio quality, haptic quality, power consumption, battery life, latency, reliability, or any combination thereof; and the application is a multimedia application, a URLLC application, an IoT application, or any combination thereof.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for reduced processing, reduced power consumption, and more efficient utilization of communication resources.

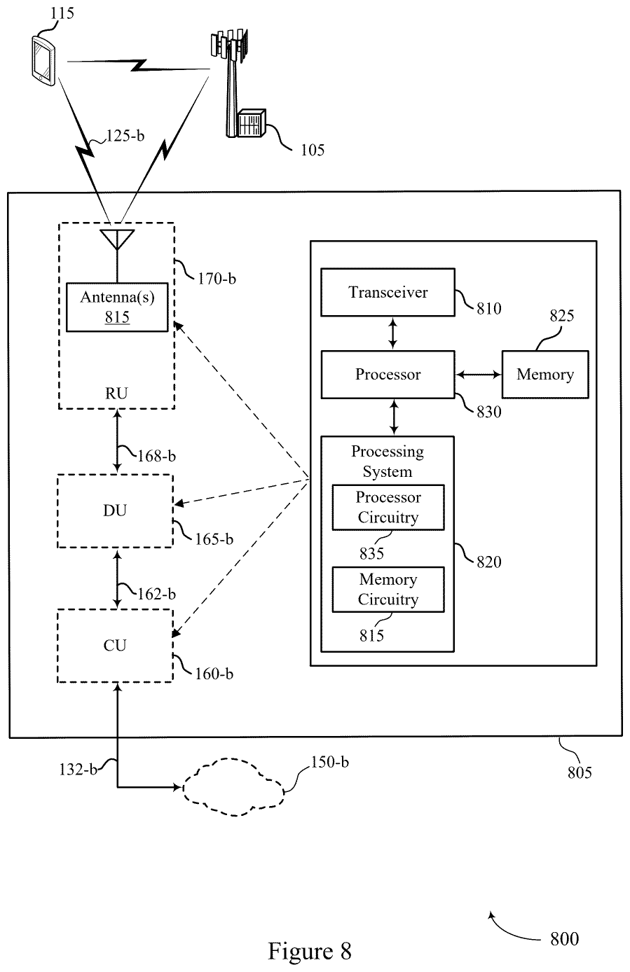

FIG. 8 shows an example of a system 800 including a device 805 that supports recommended bitrate with UX awareness. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 700. For example, the processing system 820 may include processor circuitry 835 and memory circuitry 840 that stores code, and the processing system 820 may be configured to cause the device 805 to perform operations that support recommended bitrate with UX awareness. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for improved communication reliability, reduced latency, improved UX, reduced power consumption, more efficient utilization of communication resources, improved coordination between devices, and longer battery life.

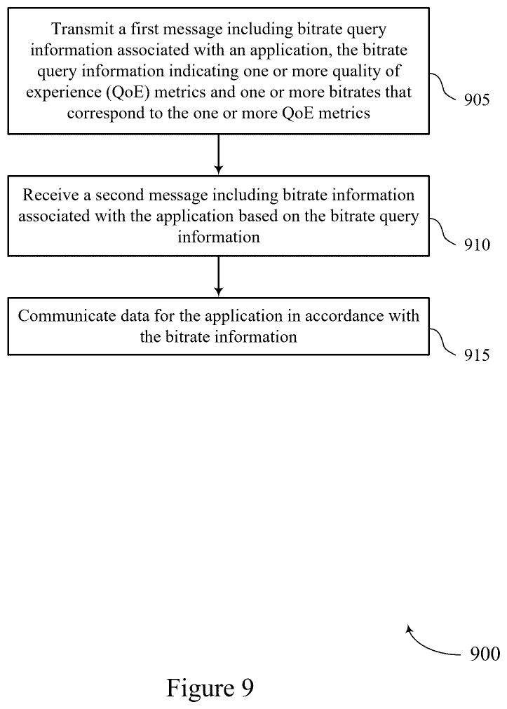

FIG. 9 shows an example of a method 900 that supports recommended bitrate with UX awareness. Operations of the method 900 may be performed by a UE or its components (such as using a processing system configured to cause the UE 115 to perform one or more of the operations) as described herein.

At 905, the method may include transmitting a first message including bitrate query information associated with an application, the bitrate query information indicating one or more QoE metrics and one or more bitrates that correspond to the one or more QoE metrics. In some examples, aspects of the operations of 905 may be performed by a bitrate query component 525.

At 910, the method may include receiving a second message including bitrate information associated with the application based on the bitrate query information. In some examples, aspects of the operations of 910 may be performed by a bitrate configuration component 530.

At 915, the method may include communicating data for the application in accordance with the bitrate information. In some examples, aspects of the operations of 915 may be performed by a data communication component 535.

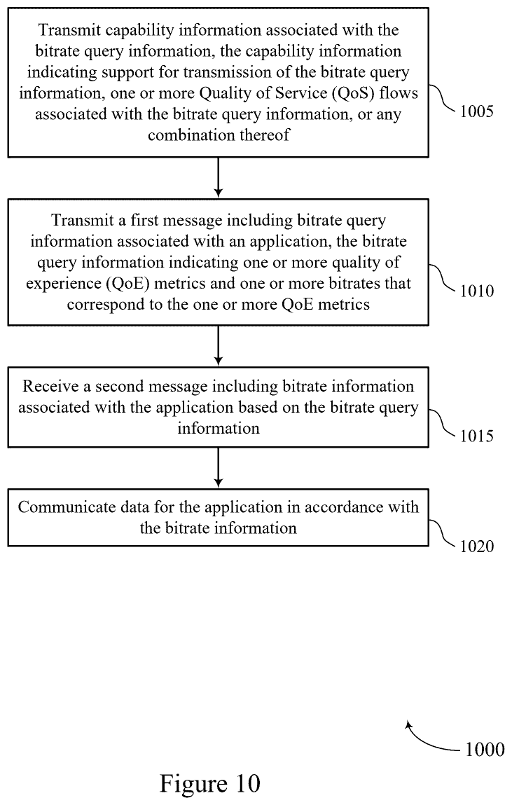

FIG. 10 shows an example of a method 1000 that supports recommended bitrate with UX awareness. Operations of the method 1000 may be performed by a UE or its components (such as using a processing system configured to cause the UE 115 to perform one or more of the operations) as described herein.

At 1005, the method may include transmitting capability information associated with the bitrate query information, the capability information indicating support for transmission of the bitrate query information, one or more QoS flows associated with the bitrate query information, or any combination thereof. In some examples, aspects of the operations of 1005 may be performed by a capability component 545.

At 1010, the method may include transmitting a first message including bitrate query information associated with an application, the bitrate query information indicating one or more QoE metrics and one or more bitrates that correspond to the one or more QoE metrics. In some examples, aspects of the operations of 1010 may be performed by a bitrate query component 525.

At 1015, the method may include receiving a second message including bitrate information associated with the application based on the bitrate query information. In some examples, aspects of the operations of 1015 may be performed by a bitrate configuration component 530.

At 1020, the method may include communicating data for the application in accordance with the bitrate information. In some examples, aspects of the operations of 1020 may be performed by a data communication component 535.

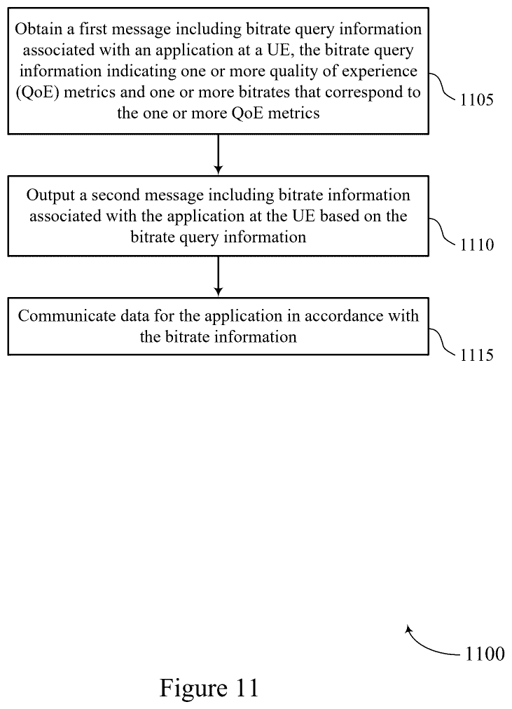

FIG. 11 shows an example of a method 1100 that supports recommended bitrate with UX awareness. Operations of the method 1100 may be performed by a network entity 105 or its components (such as using a processing system configured to cause the network entity to perform one or more operations) as described herein.

At 1105, the method may include obtaining a first message including bitrate query information associated with an application at a UE, the bitrate query information indicating one or more QoE metrics and one or more bitrates that correspond to the one or more QoE metrics. In some examples, aspects of the operations of 1105 may be performed by a bitrate query component 725.

At 1110, the method may include outputting a second message including bitrate information associated with the application at the UE based on the bitrate query information. In some examples, aspects of the operations of 1110 may be performed by a bitrate configuring component 730.

At 1115, the method may include communicating data for the application in accordance with the bitrate information. In some examples, aspects of the operations of 1115 may be performed by a data communication component 735.

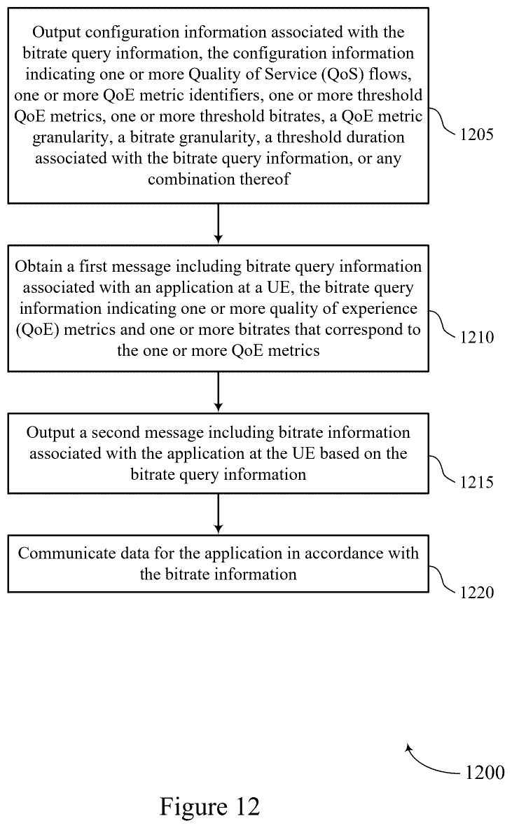

FIG. 12 shows an example of a method 1200 that supports recommended bitrate with UX awareness. Operations of the method 1200 may be performed by a network entity 105 or its components (such as using a processing system configured to cause the network entity to perform one or more operations) as described herein.

At 1205, the method may include outputting configuration information associated with the bitrate query information, the configuration information indicating one or more QoS flows, one or more QoE metric identifiers, one or more threshold QoE metrics, one or more threshold bitrates, a QoE metric granularity, a bitrate granularity, a threshold duration associated with the bitrate query information, or any combination thereof. In some examples, aspects of the operations of 1205 may be performed by a bitrate query configuring component 740.

At 1210, the method may include obtaining a first message including bitrate query information associated with an application at a UE, the bitrate query information indicating one or more QoE metrics and one or more bitrates that correspond to the one or more QoE metrics. In some examples, aspects of the operations of 1210 may be performed by a bitrate query component 725.

At 1215, the method may include outputting a second message including bitrate information associated with the application at the UE based on the bitrate query information. In some examples, aspects of the operations of 1215 may be performed by a bitrate configuring component 730.

At 1220, the method may include communicating data for the application in accordance with the bitrate information. In some examples, aspects of the operations of 1220 may be performed by a data communication component 735.

The following provides an overview of aspects of the present disclosure:

Aspect 1: A method for wireless communications at a UE, comprising: transmitting a first message comprising bitrate query information associated with an application, the bitrate query information indicating one or more QoE metrics and one or more bitrates that correspond to the one or more QoE metrics; receiving a second message comprising bitrate information associated with the application based at least in part on the bitrate query information; and communicating data for the application in accordance with the bitrate information.

Aspect 2: The method of aspect 1, wherein transmitting the first message further comprises: transmitting the first message comprising the bitrate query information that indicates a plurality of QoE metrics of a QoE-bitrate curve associated with the application and a plurality of bitrates of the QoE-bitrate curve that correspond to the plurality of QoE metrics.

Aspect 3: The method of aspect 2, further comprising: obtaining the QoE-bitrate curve from an application server associated with the application.

Aspect 4: The method of any of aspects 2 through 3, wherein an order of the plurality of QoE metrics and the plurality of bitrates in the bitrate query information is based at least in part on a priority associated with one or more of the plurality of QoE metrics, a priority associated with one or more of the plurality of bitrates, or both.

Aspect 5: The method of any of aspects 1 through 4, wherein transmitting the first message further comprises: transmitting the first message comprising the bitrate query information that indicates the one or more bitrates in the bitrate query information corresponding to one or more maximum bitrates, one or more requested bitrates, one or more average bitrates, or any combination thereof.

Aspect 6: The method of any of aspects 1 through 5, wherein transmitting the first message further comprises: transmitting the first message comprising the bitrate query information that indicates the one or more QoE metrics including a peak signal-to-noise ratio, a video multimethod assessment fusion metric, a latency metric, a power consumption metric, a reliability metric, or any combination thereof.

Aspect 7: The method of any of aspects 1 through 6, wherein the bitrate query information comprises one or more logical channel identifiers, one or more Quality of Service flow identifiers, or any combination thereof, associated with the data for the application.

Aspect 8: The method of any of aspects 1 through 7, wherein the bitrate query information comprises a first bitrate and one or more delta bitrates based at least in part on the first bitrate, or the bitrate query information comprises a first QoE metric and one or more delta QoE metrics based at least in part on the first QoE metric, or both.

Aspect 9: The method of any of aspects 1 through 8, wherein communicating the data for the application comprises: communicating the data for the application according to the bitrate information for a duration based at least in part on the bitrate query information.

Aspect 10: The method of aspect 9, wherein the duration corresponds to a quantity of time, a quantity of PDU sets, a quantity of PDU bursts, a quantity of video frames, or any combination thereof.

Aspect 11: The method of any of aspects 9 through 10, wherein the duration is based at least in part on a duration indicated by the bitrate query information.

Aspect 12: The method of any of aspects 1 through 11, wherein the bitrate information in the second message indicates a first bitrate from the one or more bitrates indicated by the first message or a second bitrate that is based at least in part on the one or more bitrates.

Aspect 13: The method of any of aspects 1 through 12, wherein the bitrate information in the second message indicates a QoE metric of the one or more QoE metrics or an index of the one or more QoE metrics.

Aspect 14: The method of any of aspects 1 through 13, further comprising: receiving configuration information associated with the bitrate query information, the configuration information comprising a periodicity associated with transmission of the bitrate query information, trigger information associated with transmission of the bitrate query information, threshold information associated with transmission of the bitrate query information, or any combination thereof.

Aspect 15: The method of any of aspects 1 through 14, further comprising: receiving configuration information associated with the bitrate query information, the configuration information indicating one or more QoS flows, one or more QoE metric identifiers, one or more threshold QoE metrics, one or more threshold bitrates, a QoE metric granularity, a bitrate granularity, a threshold duration associated with the bitrate query information, or any combination thereof.

Aspect 16: The method of any of aspects 1 through 15, further comprising: transmitting capability information associated with the bitrate query information, the capability information indicating support for transmission of the bitrate query information, one or more QoS flows associated with the bitrate query information, or any combination thereof.

Aspect 17: The method of any of aspects 1 through 16, wherein the bitrate query information is associated with video information, audio information, haptic information, Internet of Things (IoT) information, or any combination thereof.

Aspect 18: A method for wireless communications at a network node, comprising: obtaining a first message comprising bitrate query information associated with an application at a UE, the bitrate query information indicating one or more QoE metrics and one or more bitrates that correspond to the one or more QoE metrics; outputting a second message comprising bitrate information associated with the application at the UE based at least in part on the bitrate query information; and communicating data for the application in accordance with the bitrate information.

Aspect 19: The method of aspect 18, wherein the bitrate query information indicates a plurality of QoE metrics of a QoE-bitrate curve associated with the application and a plurality of bitrates of the QoE-bitrate curve that correspond to the plurality of QoE metrics.

Aspect 20: The method of aspect 19, further comprising: outputting the QoE-bitrate curve to an application server associated with the application.

Aspect 21: The method of any of aspects 19 through 20, wherein an order of the plurality of QoE metrics and the plurality of bitrates in the bitrate query information is based at least in part on a priority associated with one or more of the plurality of QoE metrics, a priority associated with one or more of the plurality of bitrates, or both.

Aspect 22: The method of any of aspects 18 through 21, wherein the one or more bitrates in the bitrate query information correspond to one or more maximum bitrates, one or more requested bitrates, one or more average bitrates, or any combination thereof.

Aspect 23: The method of any of aspects 18 through 22, wherein the one or more QoE metrics include a peak signal-to-noise ratio, a video multimethod assessment fusion metric, a latency metric, a power consumption metric, a reliability metric, or any combination thereof.

Aspect 24: The method of any of aspects 18 through 23, wherein the bitrate query information comprises one or more logical channel identifiers, one or more Quality of Service flow identifiers, or any combination thereof, associated with the data for the application.

Aspect 25: The method of any of aspects 18 through 24, wherein the bitrate query information comprises a first bitrate and one or more delta bitrates based at least in part on the first bitrate, or the bitrate query information comprises a first QoE metric and one or more delta QoE metrics based at least in part on the first QoE metric, or both.

Aspect 26: The method of any of aspects 18 through 25, wherein communicating the data for the application comprises: communicating the data for the application according to the bitrate for a duration based at least in part on the bitrate query information.

Aspect 27: The method of aspect 26, wherein the duration corresponds to a quantity of time, a quantity of PDU sets, a quantity of PDU bursts, a quantity of video frames, or any combination thereof.

Aspect 28: The method of any of aspects 26 through 27, wherein the duration is based at least in part on a duration indicated by the bitrate query information.

Aspect 29: The method of any of aspects 18 through 28, wherein the bitrate information in the second message indicates a first bitrate from the one or more bitrates indicated by the first message or a second bitrate that is based at least in part on the one or more bitrates.

Aspect 30: The method of any of aspects 18 through 29, wherein the bitrate information in the second message indicates a QoE metric of the one or more QoE metrics or an index of the one or more QoE metrics.

Aspect 31: The method of any of aspects 18 through 30, further comprising: outputting configuration information associated with the bitrate query information, the configuration information comprising a periodicity associated with transmission of the bitrate query information, trigger information associated with transmission of the bitrate query information, threshold information associated with transmission of the bitrate query information, or any combination thereof.

Aspect 32: The method of any of aspects 18 through 31, further comprising: outputting configuration information associated with the bitrate query information, the configuration information indicating one or more QoS flows, one or more QoE metric identifiers, one or more threshold QoE metrics, one or more threshold bitrates, a QoE metric granularity, a bitrate granularity, a threshold duration associated with the bitrate query information, or any combination thereof.

Aspect 33: The method of any of aspects 18 through 32, further comprising: obtaining capability information associated with the bitrate query information, the capability information indicating support for transmission of the bitrate query information, one or more QoS flows associated with the bitrate query information, or any combination thereof.

Aspect 34: The method of any of aspects 18 through 33, wherein the bitrate query information is associated with video information, audio information, haptic information, IoT information, or any combination thereof.

Aspect 35: A UE for wireless communications, comprising a processing system that includes processor circuitry and memory circuitry that stores code, the processing system configured to cause the UE to perform a method of any of aspects 1 through 17.

Aspect 36: A UE for wireless communications, comprising at least one means for performing a method of any of aspects 1 through 17.

Aspect 37: A non-transitory computer-readable medium storing code for wireless communications, the code comprising instructions executable by one or more processors to perform a method of any of aspects 1 through 17.

Aspect 38: A network node for wireless communications, comprising a processing system that includes processor circuitry and memory circuitry that stores code, the processing system configured to cause the network node to perform a method of any of aspects 18 through 34.

Aspect 39: A network node for wireless communications, comprising at least one means for performing a method of any of aspects 18 through 34.

Aspect 40: A non-transitory computer-readable medium storing code for wireless communications, the code comprising instructions executable by one or more processors to perform a method of any of aspects 18 through 34.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code) stored in memory circuitry or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
transmit a first message comprising bitrate query information associated with an application, the bitrate query information indicating one or more quality of experience (QoE) metrics and one or more bitrates that correspond to the one or more QoE metrics;
receive a second message comprising bitrate information associated with the application based at least in part on the bitrate query information; and
communicate data for the application in accordance with the bitrate information.

2. The UE of claim 1, wherein, to transmit the first message, the processing system is further configured to cause the UE to:
transmit the first message comprising the bitrate query information that indicates a plurality of QoE metrics of a QoE-bitrate curve associated with the application and a plurality of bitrates of the QoE-bitrate curve that correspond to the plurality of QoE metrics.

3. The UE of claim 2, wherein the processing system is further configured to cause the UE to:
obtain the QoE-bitrate curve from an application server associated with the application.

4. The UE of claim 2, wherein an order of the plurality of QoE metrics and the plurality of bitrates in the bitrate query information is based at least in part on a priority associated with one or more of the plurality of QoE metrics, a priority associated with one or more of the plurality of bitrates, or both.

5. The UE of claim 1, wherein, to transmit the first message, the processing system is further configured to cause the UE to:
transmit the first message comprising the bitrate query information that indicates the one or more bitrates in the bitrate query information corresponding to one or more maximum bitrates, one or more requested bitrates, one or more average bitrates, or any combination thereof.

6. The UE of claim 1, wherein, to transmit the first message, the processing system is further configured to cause the UE to:
transmit the first message comprising the bitrate query information that indicates the one or more QoE metrics including a peak signal-to-noise ratio, a video multimethod assessment fusion metric, a latency metric, a power consumption metric, a reliability metric, or any combination thereof.

7. The UE of claim 1, wherein the bitrate query information comprises one or more logical channel identifiers, one or more Quality of Service flow identifiers, or any combination thereof, associated with the data for the application.

8. The UE of claim 1, wherein the bitrate query information comprises a first bitrate and one or more delta bitrates based at least in part on the first bitrate, or the bitrate query information comprises a first QoE metric and one or more delta QoE metrics based at least in part on the first QoE metric, or both.

9. The UE of claim 1, wherein, to communicate the data for the application, the processing system is configured to cause the UE to:
communicate the data for the application according to the bitrate information for a duration based at least in part on the bitrate query information.

10. The UE of claim 9, wherein the duration corresponds to a quantity of time, a quantity of packet data unit (PDU) sets, a quantity of PDU bursts, a quantity of video frames, or any combination thereof.

11. The UE of claim 1, wherein the bitrate information in the second message indicates a QoE metric of the one or more QoE metrics or an index of the one or more QoE metrics.

12. The UE of claim 1, wherein the processing system is further configured to cause the UE to:
receive configuration information associated with the bitrate query information, the configuration information indicating a periodicity associated with transmission of the bitrate query information, trigger information associated with transmission of the bitrate query information, threshold information associated with transmission of the bitrate query information, one or more Quality of Service (QoS) flows, one or more QoE metric identifiers, one or more threshold QoE metrics, one or more threshold bitrates, a QoE metric granularity, a bitrate granularity, a threshold duration associated with the bitrate query information, or any combination thereof.

13. The UE of claim 1, wherein the processing system is further configured to cause the UE to:
transmit capability information associated with the bitrate query information, the capability information indicating support for transmission of the bitrate query information, one or more Quality of Service (QoS) flows associated with the bitrate query information, or any combination thereof.

14. The UE of claim 1, wherein:
the one or more QoE metrics include video quality, audio quality, haptic quality, power consumption, battery life, latency, reliability, or any combination thereof; and
the application is a multimedia application, an ultra-reliable low latency communications (URLLC) application, an Internet of Things (IoT) application, or any combination thereof.

15. A network node, comprising:
a processing system that includes processor circuitry and memory circuitry that stores code, the processing system configured to cause the network node to:
obtain a first message comprising bitrate query information associated with an application at a user equipment (UE), the bitrate query information indicating one or more quality of experience (QoE) metrics and one or more bitrates that correspond to the one or more QoE metrics;
output a second message comprising bitrate information associated with the application at the UE based at least in part on the bitrate query information; and
communicate data for the application in accordance with the bitrate information.

16. The network node of claim 15, wherein the bitrate query information indicates a plurality of QoE metrics of a QoE-bitrate curve associated with the application and a plurality of bitrates of the QoE-bitrate curve that correspond to the plurality of QoE metrics.

17. The network node of claim 16, wherein the processing system is further configured to cause the network node to:
output the QoE-bitrate curve to an application server associated with the application.

18. The network node of claim 15, wherein the processing system is further configured to cause the network node to:
output configuration information associated with the bitrate query information, the configuration information indicating a periodicity associated with transmission of the bitrate query information, trigger information associated with transmission of the bitrate query information, threshold information associated with transmission of the bitrate query information, one or more Quality of Service (QoS) flows, one or more QoE metric identifiers, one or more threshold QoE metrics, one or more threshold bitrates, a QoE metric granularity, a bitrate granularity, a threshold duration associated with the bitrate query information or any combination thereof.

19. The network node of claim 15, wherein the processing system is further configured to cause the network node to:
obtain capability information associated with the bitrate query information, the capability information indicating support for transmission of the bitrate query information, one or more Quality of Service (QoS) flows associated with the bitrate query information, or any combination thereof.

20. A method for wireless communications at a user equipment (UE), comprising:
transmitting a first message comprising bitrate query information associated with an application, the bitrate query information indicating one or more quality of experience (QoE) metrics and one or more bitrates that correspond to the one or more QoE metrics;
receiving a second message comprising bitrate information associated with the application based at least in part on the bitrate query information; and
communicating data for the application in accordance with the bitrate information.
